(19) United States
(12) Patent Application Publication
(10) Pub. No.: US 2016/0280026 A1
(43) Pub. Date: Sep. 29, 2016

(54) Four-Bag Vehicle Suspension

(71) Applicant: Hendrickson USA, L.L.C., Itasca, IL (US)

(72) Inventor: Michael Phillips, Lombard, IL (US)

(21) Appl. No.: 15/077,100

(22) Filed: Mar. 22, 2016

Related U.S. Application Data
(60) Provisional application No. 62/138,858, filed on Mar. 26, 2015.

(51) Int. Cl. B60G 9/02

(52) U.S. Cl. CPC B60G 9/02; B60G 2200/31; B60G 2200/32

(57) ABSTRACT

A vehicle suspension having front and rear cross members each having a vertically extending base, an upper flange, a lower flange, a left side air spring support, and a right side air spring support, left and right side longitudinal members extending between the front cross member and the rear cross member, each having a vertically extending base, an upper flange, and a lower flange, wherein the upper and lower flanges on the left side longitudinal member are bolted to the upper and lower flanges of a left side of the front and rear cross members, and wherein the upper and lower flanges on the right side longitudinal member are bolted to the upper and lower flanges of a right side of the front and rear cross members.

### BACKGROUND

The present invention generally relates to vehicle suspensions. More particularly, the present invention relates to vehicle suspensions having a frame assembly base for use with four-air spring or four-bag suspensions commonly used with coaches and passenger buses. The use of air springs provides a great deal of riding comfort for passengers having a soft suspension. In addition, because of the wide spacing that may be used with air springs, the use of air springs also provides a high degree of roll stiffness.

Existing four-bag suspension designs typically use castings or forgings that are welded together for the four-bag frame assembly components which support the axle. Castings and forging are heavy and typically require the four-bag frame assembly to be built on site where they will be installed, as once the frame assembly components are assembled and welded together they are difficult to ship. In addition, different customers desire differing four-bag frame assembly dimensions based on their particular needs. As a result, it would be desirable to provide a four-bag frame assembly that is lighter than typical designs, and that can be readily modified to adapt to particular customer demands.

### SUMMARY

In one aspect, a vehicle suspension is provided having front and rear cross members each having a vertically extending base, an upper flange, a lower flange, a left side air spring support, and a right side air spring support, left and right side longitudinal members extending between the front cross member and the rear cross member, each having a vertically extending base, an upper flange, and a lower flange, wherein the upper and lower flanges on the left side longitudinal member are bolted to the upper and lower flanges of a left side of the front and rear cross members, and wherein the upper and lower flanges on the right side longitudinal member are bolted to the upper and lower flanges of a right side of the front and rear cross members. In some embodiments, the cross members and longitudinal members are C-channels having a C-shaped cross-section, and in other embodiments the cross members and longitudinal members may be I-beams having an I-shaped cross section, or other geometries suitable for bolted connection may be used. The use of C-channels for the cross members and longitudinal members allows for them to be of a lighter weight in comparison to castings and forgings. The use of C-channels allows for a reduction in material required that provides a cost savings to the manufacturer, and provides for greater fuel efficiency for the vehicle in which the suspension is installed.

The front and rear cross members may advantageously be bolted to the left and right side longitudinal members as well. The upper flanges of the cross members are bolted to the upper flanges of the longitudinal members and the lower flanges of the cross members are bolted to the lower flanges of the longitudinal members. A bolted connection between the flanges of the cross members and longitudinal members advantageously allows for the cross members and longitudinal members to be shipped as components in an unbolted state. In addition, the bolted connections allow for greater flexibility in the frame assembly design. For example, if a wider spacing is required for a particular customer, the C-channels can be provided with different bolt-hole patterns to accommodate the particular customer requirements, using the same basic C-channel part. This provides a significant advantage over welded frame assemblies. Furthermore, damaged components may be more easily removed and replaced as compared to welded designs where the entire suspension may need to be replaced.

In addition, the front and rear cross members may also advantageously have the same size and dimensions, so that a single C-channel can be used as the front or rear cross member. Similarly, the right and left side longitudinal members may also have the same size and dimensions, so that a single C-channel can be used as either the right side or left side longitudinal member. Thus, a single part number may be used for the front and rear cross members and a single part number may be used for the right and left side longitudinal members, cutting the cost of inventory in half.

In another aspect, a vehicle suspension for supporting an axle of a vehicle is provided including a front cross member having a vertically extending base, an upper flange extending from a top of the base, a lower flange extending from a bottom of the base, a left side air spring support, and a right side air spring support, a rear cross member having a vertically extending base, an upper flange extending from a top of the base, a lower flange extending from a bottom of the base, a left side air spring support, and a right side air spring support, a left side longitudinal member extending between the front cross member and the rear cross member, the left-side longitudinal member having a vertically extending base, an upper flange extending from a top of the base, and a lower flange extending from a bottom of the base, a right side longitudinal member extending between the front cross member and the rear cross member, the right side longitudinal member having a vertically extending base, an upper flange extending from a top of the base, and a lower flange extending from a bottom of the base, wherein the upper flange on a front end of the left side longitudinal member has one or more bolt holes corresponding to one more bolt holes on the upper flange of a left side of the front cross member adapted to provide a bolted connection between the upper flange of the left side longitudinal member and the upper flange of the front cross member, wherein the lower flange on a front end of the left side longitudinal member has one or more bolt holes corresponding to one more bolt holes on the lower flange of the left side of the front cross member adapted to provide a bolted connection between the lower flange of the left side longitudinal member and the lower flange of the front cross member, wherein the upper flange on a rear end of the left side longitudinal member has one or more bolt holes corresponding to one more bolt holes on the upper flange of a left side of the rear cross member adapted to provide a bolted connection between the upper flange of the left side longitudinal member and the upper flange of the rear cross member, wherein the lower flange on a rear end of the left side longitudinal member has one or more bolt holes corresponding to one more bolt holes on the lower flange of the left side of the rear cross member adapted to provide a bolted connection between the lower flange of the left side longitudinal member and the lower flange of the rear cross member, wherein the upper flange on a front end of the right side longitudinal member has one or more bolt holes corresponding to one more bolt holes on the upper flange of a right side of the front cross member adapted to provide a bolted connection between the upper flange of the right side longitudinal member and the upper flange of the front cross member, wherein the lower flange on a front end of the right side longitudinal member has one or more bolt holes corresponding to one more bolt holes on the lower flange of the right side of the front cross member adapted to provide a bolted connection between the lower flange of the right side longitudinal member and the lower flange of the front cross member, wherein the upper flange on a rear end of the right side longitudinal member has one or more bolt holes corresponding to one more bolt holes on the upper flange of a right side of the rear cross member adapted to provide a bolted connection between the upper flange of the right side longitudinal member and the upper flange of the rear cross member, and wherein the lower flange on a rear end of the right side longitudinal member has one or more bolt holes corresponding to one more bolt holes on the lower flange of the right side of the rear cross member adapted to provide a bolted connection between the lower flange of the right side longitudinal member and the lower flange of the rear cross member.

In a further aspect, a vehicle suspension for supporting an axle of a vehicle is provided including a front cross member having a vertically extending base, an upper flange extending from a top of the base, a lower flange extending from a bottom of a base, a left side air spring support, and a right side air spring support, a rear cross member having a vertically extending base, an upper flange extending from a top of the base, a lower flange extending from a bottom of a base, a left side air spring support, and a right side air spring support, a left side longitudinal member extending between the front cross member and the rear cross member, the left-side longitudinal member having a vertically extending base, an upper flange extending from a top of the base, and a lower flange extending from a bottom of a base, a right side longitudinal member extending between the front cross member and the rear cross member, the right side longitudinal member having a vertically extending base, an upper flange extending from a top of the base, and a lower flange extending from a bottom of a base, wherein the upper flange on a front end of the left side longitudinal member is bolted to the upper flange of a left side of the front cross member, wherein the lower flange on a front end of the left side longitudinal member is bolted to the lower flange of the left side of the front cross member, wherein the upper flange on a rear end of the left side longitudinal member is bolted to the upper flange of a left side of the rear cross member, wherein the lower flange on a rear end of the left side longitudinal member is bolted to the lower flange of the left side of the rear cross member, wherein the upper flange on a front end of the right side longitudinal member is bolted to the front cross member, wherein the lower flange on a front end of the right side longitudinal member is bolted to the lower flange of the right side of the front cross member, wherein the upper flange on a rear end of the right side longitudinal member is bolted to the upper flange of a right side of the rear cross member, and wherein the lower flange on a rear end of the right side longitudinal member is bolted to the lower flange of the right side of the rear cross member.

### BRIEF DESCRIPTION OF THE DRAWINGS

Exemplary embodiments of the invention are described herein with reference to the drawings, wherein like parts are designated by like reference numerals, and wherein:

FIG. 1 is a front perspective view of four-bag vehicle suspension 50 with axle 90 positioned thereon, according to an example embodiment;

FIG. 2 is a perspective view of vehicle suspension 50 shown in FIG. 1 with air springs 80a-d positioned on the air spring supports;

FIG. 3 is a perspective view of the vehicle suspension 50 shown in FIGS. 1 and 2 without the air springs;

FIG. 4 is a top view of the vehicle suspension 50 shown in FIG. 3;

FIG. 5 is a bottom view of the vehicle suspension 50 shown in FIGS. 3 and 4;

FIG. 6A is a right side view of vehicle suspension 50 shown in FIGS. 3-5;

FIG. 6B is a left side view of vehicle suspension 50 shown in FIGS. 3-6A;

FIG. 7A is a front view of vehicle suspension 50 shown in FIGS. 3-6B;

FIG. 7B is a rear view of vehicle suspension 50 shown in FIGS. 3-7A;

FIG. 8A is a close up front perspective view of vehicle suspension 50 shown in FIG. 1, showing control rod attachment 66 positioned within right side longitudinal member 62;

FIG. 8B is a close up front perspective view of vehicle suspension 50 shown in FIG. 8A with front cross member 70 removed to better show control rod attachment 66; and

FIG. 9 is a close up perspective view of left side longitudinal member 62 bolted to front cross member 70, showing gusset 90 bolted to both the left side longitudinal member 62 and front cross member 70.

### DETAILED DESCRIPTION OF THE INVENTION

The present embodiments are directed to a four-air spring suspension (also referred to as a four-bag suspension) typically used on buses and coaches, and may be used in the rear suspension of a bus chassis. The air springs provide for a soft suspension that provides a high degree of comfort for the passengers, and the large spacing of the air springs provides for a high degree of roll stiffness and stability.

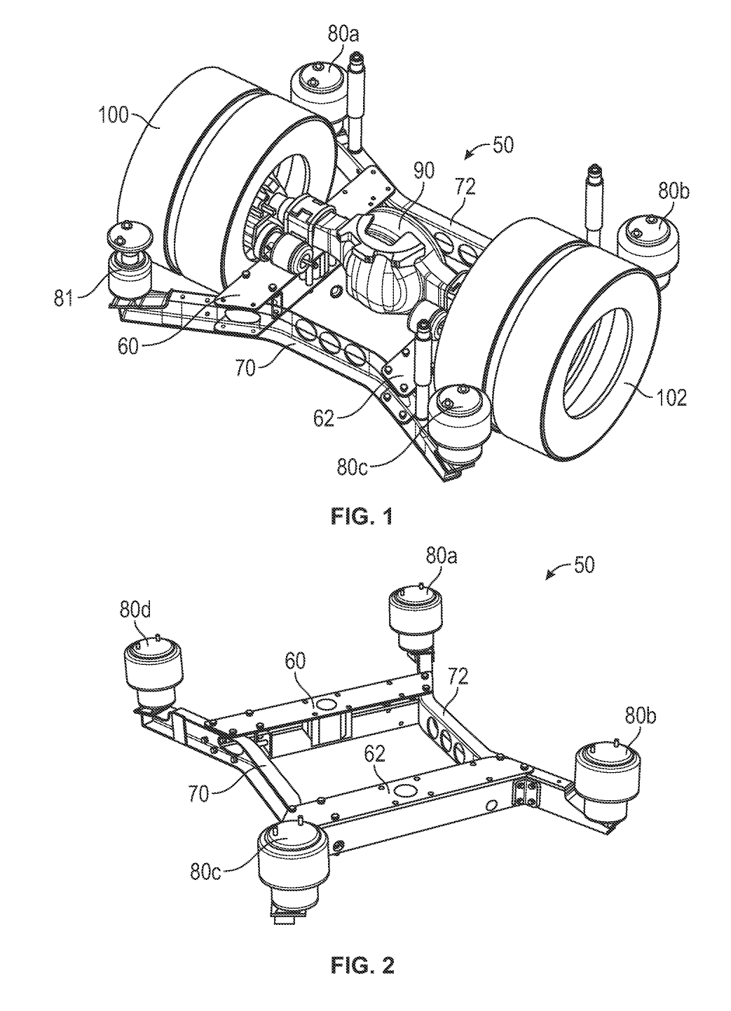

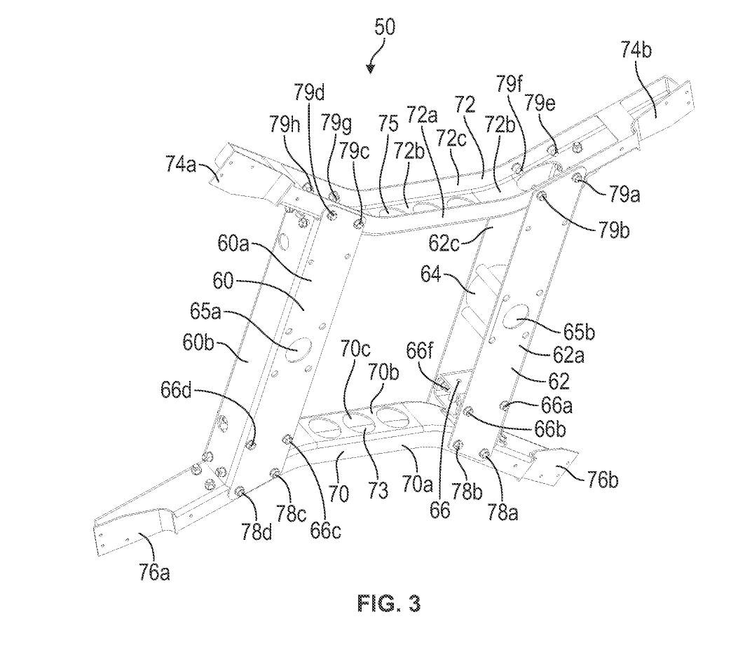

FIG. 1 is a front perspective view of four-bag vehicle suspension 50. Vehicle suspension 50 includes front cross member 70 and rear cross member 72. Front cross member 70 is bolted to left side longitudinal member 62 and also bolted to right side longitudinal member 60. Similarly, rear cross member 72 is bolted to left side longitudinal member 62 and also bolted to right side longitudinal member 60. Air springs 80a and 80b are positioned on opposite ends of the rear cross member 72. Air spring 80c is positioned on the left end of front cross member 70. A combined air spring/damper 81 is shown positioned on the right end of the front cross member, although in operation an air spring like air springs 80a-80d would be used when using air springs 80a-c and a shock absorber would be added. References to right and left side are based on looking forward from the rear cross member 72 to the front cross member 70. Vehicle suspension 50 could be utilized with four air springs, such as air springs 80a-d as shown in FIG. 2, or vehicle suspension 50 could be utilized with four combined air spring/dampers like combined air spring damper 81. Combined air spring/damper 81 may be designed in accordance with U.S. Pat. No. 8,540,222 entitled “Air Spring For A Heavy-Duty Vehicle With Damping Features” issued on Sep. 24, 2013, and assigned to the assignee of the present application, and incorporated by reference herein. An advantage of using the combined air spring/damper is that the need for a separate shock absorber next to the air spring may be eliminated. The sizing of the air springs and/or combined air spring/dampers is dependent on the load to be carried, but are generally 12 inches in diameter. The air springs are thin-walled inflate rubber inflatable above 100 psi.

In FIG. 1, axle 90 is shown positioned over and secured to the left and right longitudinal members 60 and 62. Tire 100 is attached to axle 90 and is positioned between air spring 80a and combined air spring/damper 81, and tire 102 is attached to axle 90 and positioned between air springs 80b and 80c. Spacing should be provided to accommodate for the size of the tires 100 and 102. To accommodate the largest tires having a diameter of 295 mm on a 24.5 inch wheel or rim, the spacing between air spring 80a and combined air spring/damper 81, and the spacing between air springs 80b and 80c in some embodiments may be 61.2 inches measured from centerline to centerline of the air springs 80b and 80c. The spacing, however, is dictated by the size of the tire being used. The spacing between the rear air springs 80a and 80b, and the spacing between front air spring 80c and combined air spring/damper 81 may be 76.9 inches measured from centerline to centerline of air spring 80c and combined air spring/damper 81. Alternate spacing may be provided depending on the application.

Furthermore, the term “longitudinal” is to be construed broadly and does not require that the left and right longitudinal members 62, 60 are parallel to each other or aligned with an axial centerline of the vehicle, rather the term “longitudinal” simply means that the longitudinal members extend between the cross members 70, 72 and can be offset up to 30 degrees from the centerline of the vehicle.

FIG. 2 is a perspective view of vehicle suspension 50 shown in FIG. 1 with the axle 90 and tires 100, 102 removed, and with air spring 80d replacing combined air spring/damper 81 from FIG. 1. Thus, in FIG. 2, four air springs 80a-d are shown positioned on the ends of the front and rear cross members 70, 72. Rear cross member 72 is bolted to left and right side longitudinal members 62, 60, and front cross member 70 is bolted to left and right side longitudinal members 62, 60.

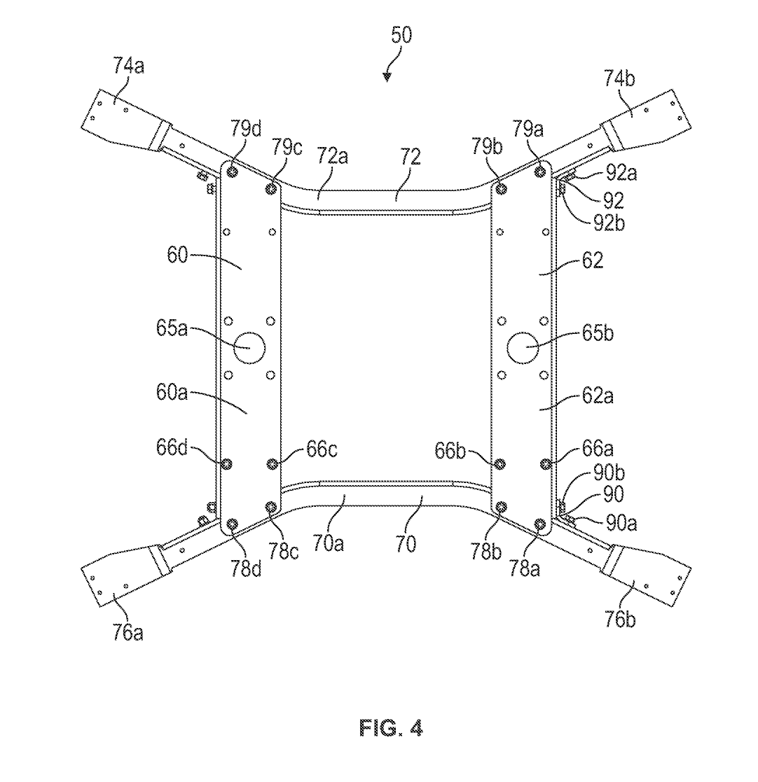

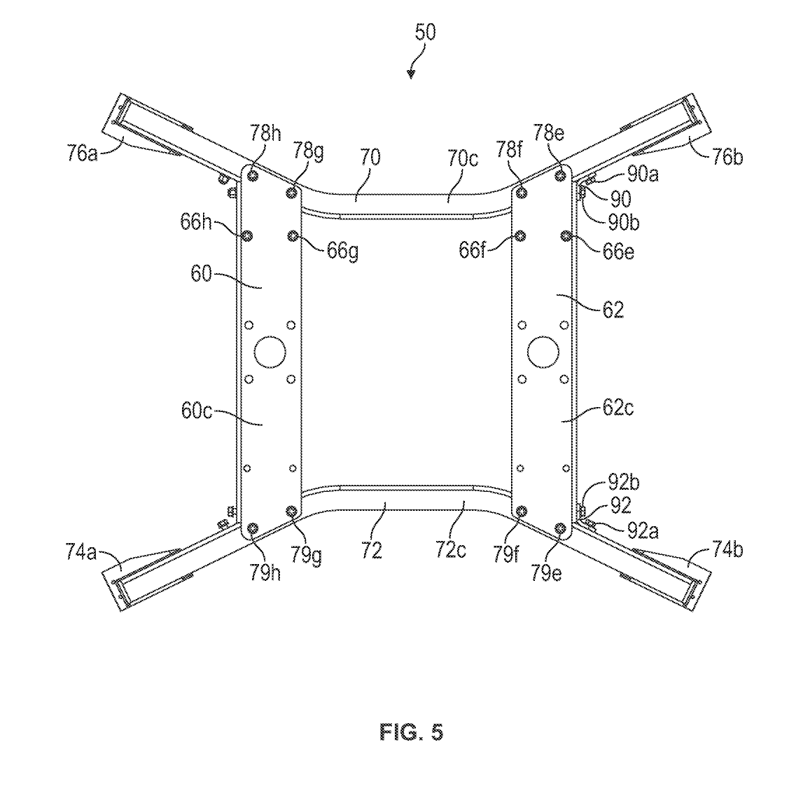

Referring now to FIGS. 3 and 4, FIG. 3 is a perspective view of the vehicle suspension 50 shown in FIG. 2 without the air springs 80a-d and FIG. 4 is a top view of vehicle suspension 50. Front cross member 70 may be constructed from a C-channel having a C-shaped cross-section including a vertically extending base 70b, an upper flange 70a, a lower flange 70c, a left side air spring support 76b, and a right side air spring support 76a. Air spring supports 76a and 76b may be welded to the front cross member 70 to provide the air spring support. One or more holes 73 may be cut out of the vertically extending base 70b to reduce weight. Similarly, rear cross member 72 may be made constructed from a C-channel having a C-shaped cross-section including a vertically extending base 72b, an upper flange 72a, a lower flange 72c, a left side air spring support 74b, and a right side air spring support 74a. Air spring supports 74a and 74b may be welded to the rear cross member 72 to provide the air spring support. One or more holes 75 may be cut out of the vertically extending base 72b to reduce weight.

Left side longitudinal member 62 extends between the front cross member 70 and the rear cross member 72. Left side longitudinal member 62 includes a vertically extending base (not visible), an upper flange 62a, and a lower flange 62c. Left side longitudinal member 62 may further include an axle seat 65b on the upper flange 62a and a baffle 64 positioned between the upper flange 62a and lower flange 62c and beneath the axle seat 65b to support the left side of an axle.

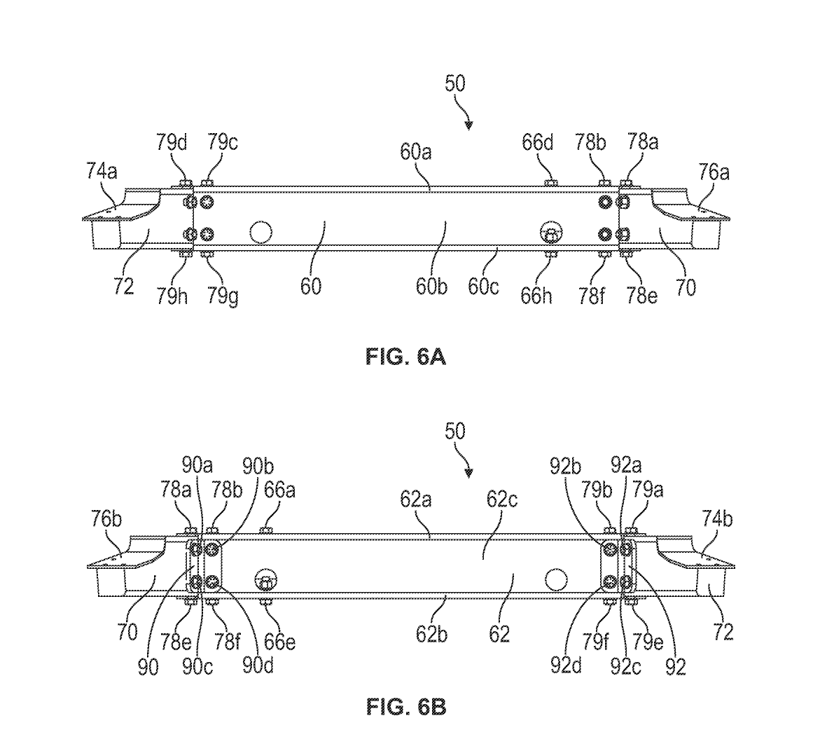

Similarly, right side longitudinal member 60 extends between the front cross member 70 and the rear cross member 72. Right side longitudinal member 60 includes a vertically extending base 60b, an upper flange 60a, and a lower flange 60c (shown in FIG. 5). Right side longitudinal member 60 may further include an axle seat 65a on the upper flange 60a and a baffle (not visible) positioned between the upper flange 60a and lower flange 60c and beneath the axle seat 65a to support the right side of an axle.

Upper flange 62a of the left side longitudinal member 62 is bolted to upper flange 70a of the front cross member 70 using bolts 78a and 78b, and as shown in FIG. 5, the lower flange 62c of left side longitudinal member 62 is bolted to the lower flange 70c of the front cross member 70 using bolts 78e and 78f. Upper flange 62a of left side longitudinal member 62 is also bolted to upper flange 72a of rear cross member 72 using bolts 79a and 79b, and as shown in FIG. 5, the lower flange 62c of left side longitudinal member 62 is bolted to the lower flange 70c of the rear cross member 70 using bolts 79e and 79f.

In some embodiments, as shown in the Figures of the present application, the cross members 70, 72, and longitudinal members are constructed of C-channels having a C-shaped cross-section and are made from 0.25 inch thick Grade 80 sheet steel, and other thicknesses and materials may also be used. In other embodiments the cross members and longitudinal members may be I-beams having an I-shaped, or have other geometry suitable for bolted attachment to each other.

The use of C-channels for the cross members 70, 72 and longitudinal members 60, 62 allows for them to be of a lighter weight in comparison to castings and forgings, and may provide up to a third less weight or more. The use of C-channels allows for a reduction in material required that provides a cost savings to the manufacturer, and provides for greater fuel efficiency for the vehicle in which the suspension is installed.

The front and rear cross members 70, 72 are advantageously bolted to the longitudinal members 60, 62 as well. The bolted connections between the flanges of the cross members and flanges of the longitudinal members allow for the cross members 70, 72 and longitudinal members 60, 62 to be shipped as components in an unbolted together state. In addition, the bolted connections allow for greater flexibility in the frame assembly design. For example, if a wider spacing is required for a particular customer, the C-channels can be provided with different bolt-hole patterns to accommodate the particular customer requirements, using the same basic C-channel part. This provides a significant advantage over welded frame assemblies.

Furthermore, if one of the cross members or longitudinal members becomes damaged, the damages component may be simply unbolted from the vehicle suspension and replaced. In welded designs, when one component becomes damaged it may be necessary to replace the entire suspension.

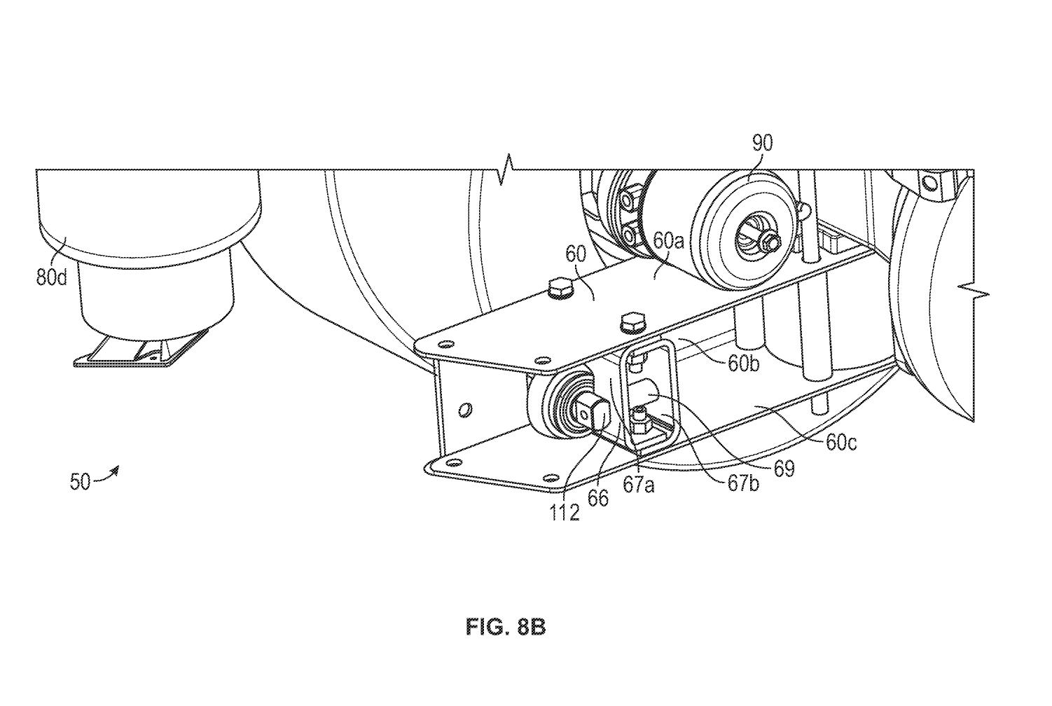

In FIG. 3, a control rod attachment 66 is shown positioned between upper flange 62a and lower flange 62c of the left side longitudinal member 62. It is bolted to the upper flange 62a using bolts 66a and 66b, and lower flange 62 using bolts 66e (shown in FIG. 5) and 66f Further details of the control rod attachment 66 are shown in FIGS. 8A and 8B and described in in greater detail below. Another control attachment (not visible) is positioned between the upper and lower flanges of the right side longitudinal member 60 and bolted to upper flange 60a with bolts 66c and 66d, and bolted to lower flange 60c with bolts 66g and 66h (shown in FIG. 5).

FIG. 5 is a bottom view of the vehicle suspension 50 shown in FIGS. 3 and 4. Lower flange 72c of rear cross member 72 is bolted to the lower flange 62c of left side longitudinal member 62 with bolts 79e and 79f, and lower flange 72c of rear cross member 72 is bolted the lower flange 60c of right side longitudinal member 60 with bolts 79g and 79h. The bottoms of air spring supports 74a and 74b are also shown in rear cross member 72. Similarly, lower flange 70c of front cross member 70 is bolted to the lower flange 62c of left side longitudinal member 62 with bolts 78e and 78f, and lower flange 70c of front cross member 70 is bolted the lower flange 60c of right side longitudinal member 60 with bolts 78g and 79h. The bottoms of air spring supports 76a and 76b are also shown in front cross member 70.

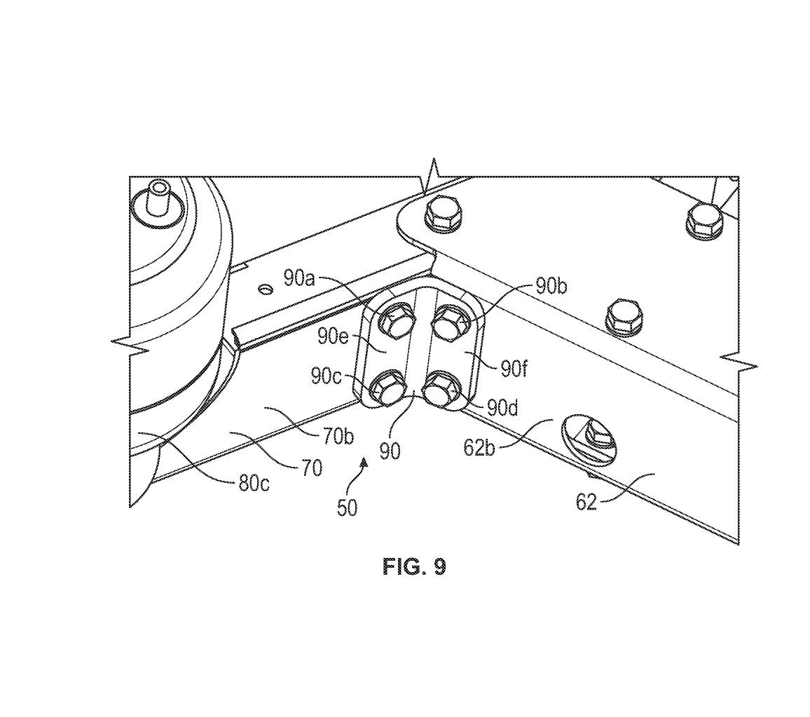

Also shown in FIG. 5 is gusset 90 bolted to front cross member 70 and left side longitudinal member 62 with bolts 90a and 90b, and gusset 92 bolted to rear cross member 72 and left side longitudinal member 62 with bolts 92a and 92b. Gussets 90 and 92 provide additional strength to vehicle suspension 50. Further details of gusset 90 are illustrated in FIG. 9 and described in further detail below. Although not shown here, it is contemplated that gussets like gussets 90 and 92 could be used on the opposite side of the vehicle suspension as well. The bolts used to attach the cross member members 70, 72, and longitudinal members 60, 62 may be Class 8 bolts having a ¾ inch diameter and tightened with class C nuts, although different sized bolts and nuts may also be used, depending on the application.

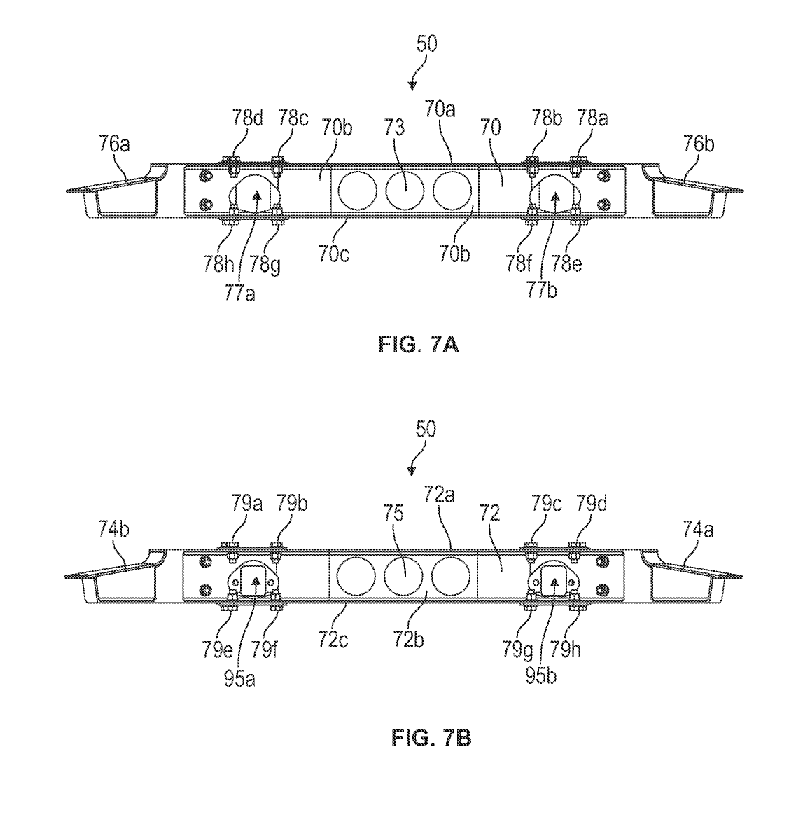

FIG. 6A is a right side view of vehicle suspension 50 shown in FIGS. 3-5. Right side longitudinal member 60 is shown with upper flange 60a bolted to front cross member 70 with bolts 78a and 78b, and lower flange 60c bolted to front cross member 70 with bolts 78e and 78f. Similarly, right side longitudinal member 60 is shown with upper flange 60a bolted to rear cross member 72 with bolts 79c and 79d, and lower flange 60c bolted to rear cross member 72 with bolts 79g and 79h.

FIG. 6B is a left side view of vehicle suspension 50 shown in FIGS. 3-6A. Left side longitudinal member 62 is shown with upper flange 62a bolted to front cross member 70 with bolts 78a and 78b, and lower flange 60c bolted to front cross member 70 with bolts 78e and 78f. Similarly, left side longitudinal member 60 is shown with upper flange 60a bolted to rear cross member 72 with bolts 79a and 79b, and lower flange 62c bolted to rear cross member 72 with bolt 79e and 79f.

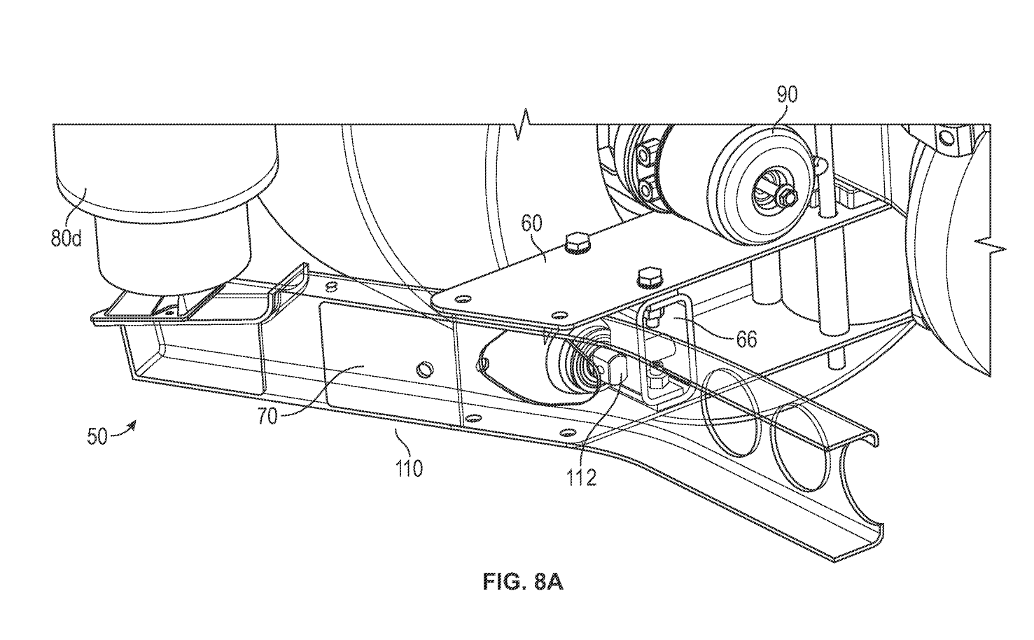

FIG. 7A is a front view of vehicle suspension 50 shown in FIGS. 3-6B. Front cross member 70 is shown with upper flange 70a bolted to left side longitudinal member 62 with bolts 78a and 78b, and lower flange 70c bolted to left side longitudinal member 62 with bolts 78e and 78f. Similarly, front cross member 70 is shown with upper flange 70a bolted to right side longitudinal member 60 with bolts 78a and 78b, and lower flange 70c bolted to left side longitudinal member 62 with bolts 78e and 78f Front cross member 70 includes holes 77a and 77b in vertically extending base 70b to provide control rod access to the control rod attachment (not shown) positioned between the upper flange 70a and lower flange 70c. Also, one or more holes 73 may be provided in vertically extending base 70b to reduce weight.

FIG. 7B is a rear view of vehicle suspension 50 shown in FIGS. 3-7A. Rear cross member 72 is shown with upper flange 72a bolted to left side longitudinal member 62 with bolts 79a and 79b, and lower flange 72c bolted to left side longitudinal member 62 with bolts 79e and 79f. Similarly, rear cross member 72 is shown with upper flange 72a bolted to right side longitudinal member 60 with bolts 79c and 79c, and lower flange 72c bolted to right side longitudinal member 60 with bolts 79g and 79h. Rear cross member 72 includes holes 95a and 95b in vertically extending base 72b to provide control rod access to the control rod attachment (not shown) positioned between the upper flange 72a and lower flange 72c. Also, one or more holes 75 may be provided in vertically extending base 72b to reduce weight.

In the present embodiments, the upper and lower flanges of the front and rear cross members are sized to fit within the upper and lower flanges of the left and right side longitudinal members. This is not required. In an alternate embodiment, the upper and lower flanges of the left and right longitudinal member may fit within the upper and lower flanges of the front and rear cross members. In such a case, the C-channel of the front and rear cross members may be flipped 180 degrees to face the left and right longitudinal members.

In one embodiment, the upper and lower flanges of the longitudinal members extend 8.9 inches from the vertically extending base. In one embodiment, the upper and lower flanges of the vertically extending base of the front and rear cross members extend 3.3 inches from the vertically extending base. In other embodiments, the upper and lower flanges may extend at different lengths from the front and rear cross members and the left and right longitudinal members. Furthermore, the distance between the upper and lower flanges of the left and right longitudinal members may be 7.1 inches, and the distance between the upper and lower flanges of the front and rear cross members may be 6.6 inches. However, the distances may be varied depending upon the application, and the distance between the upper and lower flanges of the cross members could be varied so that the longitudinal members could be nested within the cross members.

In the present embodiments, although not required, the front and rear cross members 70, 72 may also advantageously have the same size and dimensions, so that a single C-channel part can be used as the front and rear cross members. Similarly, the right and left side longitudinal members 60, 62 may also have the same size and dimensions, so that a single C-channel can be used as either the right side or left side longitudinal member. Thus, a single part number may be used for the front and rear cross members and a single part number may be used for the right and left side longitudinal members because they are interchangeable, cutting the cost of inventory in half. A few additional bolt holes may be required in the cross members depending on whether the cross member is used as a front or rear cross member to accommodate the position of the control rod attachment. However, it is more cost-efficient to have a single part number used for either the front or rear cross member than carrying two separate parts numbers for the front and rear cross members.

Additionally, based on customer requirements, the bolt-pattern spacing on the C-channels may be modified to provide for differing spacing requirements for particular customer applications. The bolted connection design provides for greater flexibility in meeting customer requirements, without requiring the need for additional components.

FIG. 8A is a close up front perspective view of vehicle suspension 50 shown in FIG. 1, control rod attachment 66 extending positioned within right side longitudinal member 62, and adapted to attachment to a control rod bushing positioned over bar pin 112. FIG. 8B is a close up front perspective view of vehicle suspension 50 shown in FIG. 8A with front cross member 70 removed to better show control rod attachment 66. Air spring 80d is shown positioned over an end of front cross member 70, and axle 90 is shown positioned over right side longitudinal member 60. In FIGS. 8A and 8B, a bar pin 112 is shown positioned within an inner bushing of a control rod (not shown). As shown in FIG. 8B, control rod attachment 66 is shown bolted into position between upper flange 60a and lower flange 60c of right side longitudinal member 60.

Control rod attachment 60, in this embodiment, is constructed of two C-channel sections 67a and 67b facing each other in a nested fashion. A bolt opening 69 extends between the two C-channel sections 67a and 67b to allow a bolt to extend therethrough and connect to bar pin 112. The two C-channel sections 67a and 67b may have a thickness of ⅜ of an inch and made of Grade 80 sheet steel, although other thicknesses and materials may also be used. A similar arrangement may be provided on the left side longitudinal member to provide a similar control rod attachment.

FIG. 9 is a close up perspective view of left side longitudinal member 62 bolted to front cross member 70, showing gusset 90 bolted to both the left side longitudinal member 62 and front cross member 70. In FIG. 9, gusset 90 is shown with flange 90b bolted to the vertically extending base 62b of left side longitudinal member 62 with bolts 90b and 90d, and flange 90e bolted to vertically extending flange 70b of front cross member 70 with bolts 90a and 90c. The gusset 90 advantageously provides additional strength and stability to the vehicle suspension 50. In some embodiments, the gusset 90 may be made of Grade 80⅜ inch thick sheet steel, although other thicknesses and materials may also be used. Gussets of this type may also be used in the other bolted connections between the front and rear cross members and the left and right side longitudinal members.

Example embodiments of the present invention have been described above. Those skilled in the art will understand that changes and modifications may be made to the described embodiments without departing from the true scope of the present invention, which is defined by the claims.

What is claimed is:

1. A vehicle suspension for supporting an axle of a vehicle, comprising:
a front cross member having a vertically extending base, an upper flange extending from a top of the base, a lower flange extending from a bottom of the base, a left side air spring support, and a right side air spring support;
a rear cross member having a vertically extending base, an upper flange extending from a top of the base, a lower flange extending from a bottom of the base, a left side air spring support, and a right side air spring support;
a left side longitudinal member extending between the front cross member and the rear cross member, the left-side longitudinal member having a vertically extending base, an upper flange extending from a top of the base, and a lower flange extending from a bottom of the base;
a right side longitudinal member extending between the front cross member and the rear cross member, the right side longitudinal member having a vertically extending base, an upper flange extending from a top of the base, and a lower flange extending from a bottom of the base;
wherein the upper flange on a front end of the left side longitudinal member has one or more bolt holes corresponding to one more bolt holes on the upper flange of a left side of the front cross member adapted to provide a bolted connection between the upper flange of the left side longitudinal member and the upper flange of the front cross member;
wherein the lower flange on a front end of the left side longitudinal member has one or more bolt holes corresponding to one more bolt holes on the lower flange of the left side of the front cross member adapted to provide a bolted connection between the lower flange of the left side longitudinal member and the lower flange of the front cross member;
wherein the upper flange on a rear end of the left side longitudinal member has one or more bolt holes corresponding to one more bolt holes on the upper flange of a left side of the rear cross member adapted to provide a bolted connection between the upper flange of the left side longitudinal member and the upper flange of the rear cross member;
wherein the lower flange on a rear end of the left side longitudinal member has one or more bolt holes corresponding to one more bolt holes on the lower flange of the left side of the rear cross member adapted to provide a bolted connection between the lower flange of the left side longitudinal member and the lower flange of the rear cross member;
wherein the upper flange on a front end of the right side longitudinal member has one or more bolt holes corresponding to one more bolt holes on the upper flange of a right side of the front cross member adapted to provide a bolted connection between the upper flange of the right side longitudinal member and the upper flange of the front cross member;
wherein the lower flange on a front end of the right side longitudinal member has one or more bolt holes corresponding to one more bolt holes on the lower flange of the right side of the front cross member adapted to provide a bolted connection between the lower flange of the right side longitudinal member and the lower flange of the front cross member;
wherein the upper flange on a rear end of the right side longitudinal member has one or more bolt holes corresponding to one more bolt holes on the upper flange of a right side of the rear cross member adapted to provide a bolted connection between the upper flange of the right side longitudinal member and the upper flange of the rear cross member; and
wherein the lower flange on a rear end of the right side longitudinal member has one or more bolt holes corresponding to one more bolt holes on the lower flange of the right side of the rear cross member adapted to provide a bolted connection between the lower flange of the right side longitudinal member and the lower flange of the rear cross member.

2. The vehicle suspension of claim 1, wherein the front cross member comprises a C-channel where the vertically extending base and upper and lower flanges of the front cross member have a C-shaped cross-section for at least a portion of the front cross member, and wherein the rear cross member comprises a C-channel where the vertically extending base and upper and lower flanges of the rear cross member have a C-shaped cross-section for at least a portion of the rear cross member.

3. The vehicle suspension of claim 2, wherein the left side longitudinal member comprises a C-channel where the vertically extending base and upper and lower flanges of the left side longitudinal member have a C-shaped cross-section for at least a portion of the left side longitudinal member, and wherein the right side longitudinal member comprises a C-channel where the vertically extending base and upper and lower flanges of the right side longitudinal member have a C-shaped cross-section for at least a portion of the right side longitudinal member.

4. The vehicle suspension of claim 1, wherein the left side longitudinal member comprises a C-channel where the vertically extending base and upper and lower flanges of the left side longitudinal member have a C-shaped cross-section for at least a portion of the left side longitudinal member, and wherein the right side longitudinal member comprises a C-channel where the vertically extending base and upper and lower flanges of the right side longitudinal member have a C-shaped cross-section for at least a portion of the right side longitudinal member.

5. The vehicle suspension of claim 1, wherein the upper and lower flanges of the front cross member are positionable between the upper and lower flanges of the left side longitudinal member, and are also positionable between the upper and lower flanges of the right side longitudinal member; and
wherein the upper and lower flanges of the rear cross member are positionable between the upper and lower flanges of the left side longitudinal member, and are also positionable between the upper and lower flanges of the right side longitudinal member.

6. The vehicle suspension of claim 1, wherein the front cross member comprises an I-beam and the rear cross member comprises an I-beam.

7. The vehicle suspension of claim 1, wherein the front cross member and rear cross member have the same size and dimensions.

8. The vehicle suspension of claim 7, wherein the left and right side longitudinal members have the same size and dimensions.

9. The vehicle suspension of claim 1, wherein a first control rod attachment is bolted into position between the upper and lower flanges of the left side longitudinal member; and
wherein a second control rod attachment is bolted into position between the upper and lower flanges of the right side longitudinal member.

10. The vehicle suspension of claim 9, wherein the first control rod attachment comprises a pair of C-channels each having a C-shaped cross section; and
wherein the second control rod attachment comprises a pair of C-channels each having a C-shaped cross section.

11. The vehicle suspension of claim 1, wherein the left side longitudinal member includes a baffle positioned between the upper and lower flanges beneath a first axle seat; and wherein the right side longitudinal member includes a baffle positioned between the upper and lower flanges beneath a second axle seat.

12. A vehicle suspension for supporting an axle of a vehicle, comprising:
a front cross member having a vertically extending base, an upper flange extending from a top of the base, a lower flange extending from a bottom of the base, a left side air spring support, and a right side air spring support;
a rear cross member having a vertically extending base, an upper flange extending from a top of the base, a lower flange extending from a bottom of the base, a left side air spring support, and a right side air spring support;
a left side longitudinal member extending between the front cross member and the rear cross member, the left-side longitudinal member having a vertically extending base, an upper flange extending from a top of the base, and a lower flange extending from a bottom of the base;
a right side longitudinal member extending between the front cross member and the rear cross member, the right side longitudinal member having a vertically extending base, an upper flange extending from a top of the base, and a lower flange extending from a bottom of the base;
wherein the upper flange on a front end of the left side longitudinal member is bolted to the upper flange of a left side of the front cross member;
wherein the lower flange on a front end of the left side longitudinal member is bolted to the lower flange of the left side of the front cross member;
wherein the upper flange on a rear end of the left side longitudinal member is bolted to the upper flange of a left side of the rear cross member;
wherein the lower flange on a rear end of the left side longitudinal member is bolted to the lower flange of the left side of the rear cross member;
wherein the upper flange on a front end of the right side longitudinal member is bolted to the front cross member;
wherein the lower flange on a front end of the right side longitudinal member is bolted to the lower flange of the right side of the front cross member;
wherein the upper flange on a rear end of the right side longitudinal member is bolted to the upper flange of a right side of the rear cross member; and
wherein the lower flange on a rear end of the right side longitudinal member is bolted to the lower flange of the right side of the rear cross member.

13. The vehicle suspension of claim 12, wherein the front cross member comprises a C-channel where the vertically extending base and upper and lower flanges of the front cross member have a C-shaped cross-section for at least a portion of the front cross member, and wherein the rear cross member comprises a C-channel where the vertically extending base and upper and lower flanges of the rear cross member have a C-shaped cross-section for at least a portion of the rear cross member.

14. The vehicle suspension of claim 13, wherein the left side longitudinal member comprises a C-channel where the vertically extending base and upper and lower flanges of the left side longitudinal member have a C-shaped cross-section for at least a portion of the left side longitudinal member, and wherein the right side longitudinal member comprises a C-channel where the vertically extending base and upper and lower flanges of the right side longitudinal member have a C-shaped cross-section for at least a portion of the right side longitudinal member.

15. The vehicle suspension of claim 12, wherein the upper and lower flanges of the front cross member are positioned between the upper and lower flanges of the left side longitudinal member, and are also positioned between the upper and lower flanges of the right side longitudinal member; and
wherein the upper and lower flanges of the rear cross member are positioned between the upper and lower flanges of the left side longitudinal member, and are also positioned between the upper and lower flanges of the right side longitudinal member.

16. The vehicle suspension of claim 12, wherein the front cross member and rear cross member have the same size and dimensions.

17. The vehicle suspension of claim 16, wherein the left and right side longitudinal members have the same size and dimensions.

18. The vehicle suspension of claim 12, wherein an air spring is positioned on each of the air spring supports on the front and rear cross members.

19. The vehicle suspension of claim 12, wherein a combined air spring/damper is positioned on each of the air spring supports on the front and rear cross members.

20. The vehicle suspension of claim 12, wherein a first control rod attachment is bolted into position between the upper and lower flanges of the left side longitudinal member; and
wherein a second control rod attachment is bolted into position between the upper and lower flanges of the right side longitudinal member.

21. The vehicle suspension of claim 20, wherein the first control rod attachment comprises a pair of C-channels each having a C-shaped cross section; and
wherein the second control rod attachment comprises a pair of C-channels each having a C-shaped cross section.

22. The vehicle suspension of claim 12 wherein the left side longitudinal member includes a baffle positioned between the upper and lower flanges beneath a first axle seat; and wherein the right side longitudinal member includes a baffle positioned between the upper and lower flanges beneath a second axle seat.

23. The vehicle suspension of claim 12, wherein a first gusset is bolted to the left side longitudinal member and bolted to the front cross member;
wherein a second gusset is bolted to the left side longitudinal member and bolted to the rear cross member;
wherein a third gusset is bolted to the right side longitudinal member and bolted to the front cross member; and
wherein a fourth gusset is bolted to the right side longitudinal member and bolted to the rear cross member.

24. The vehicle suspension of claim 13, wherein the front and rear cross members are interchangeable.

25. The vehicle suspension of claim 24, where the left and right side longitudinal members are interchangeable.
